(19) United States
(12) Patent Application Publication
(10) Pub. No.: US 2006/0222019 A1
(43) Pub. Date: Oct. 5, 2006

(54) Time stamp in the reverse path

(75) Inventors: John M. Hedin, Coon Rapids, MN (US); Donald R. Bauman, Waseca, MN (US); Jeffrey J. Cannon, St. Louis Park, MN (US)

Correspondence Address: FOGG AND ASSOCIATES, LLC, P.O. BOX 581339, MINNEAPOLIS, MN, 55458-1339, US

(73) Assignee: ADC Telecommunications, Inc., Eden Prairie, MN (US)

(21) Appl. No.: 11/095,112

(22) Filed: Mar. 31, 2005

(51) Int. Cl. H04J 3/06

(52) U.S. Cl. 370/509

(57) ABSTRACT

The synchronization of timing between devices in a communication system is presented. In one embodiment a method includes attaching a time stamp message to a page of data samples that indicates when a first one of the data samples was received by a receive engine in a host card. Passing the data samples and the time stamp message to a call processing module and synchronizing communications between the host card and the call processing module based at least in part on the time stamp message.

### CROSS REFERENCES TO RELATED APPLICATIONS

This application is related to the following co-pending United States patent applications filed on even date herewith, all of which are hereby incorporated herein by reference:

U.S. patent application Ser. No. ______ (attorney docket number 100.672US01 entitled “DYNAMIC FREQUENCY HOPPING”) and which is referred to here as the '672 application;

U.S. patent application Ser. No. ______ (attorney docket number 100.673US01 entitled “DYNAMIC DIGITAL UP AND DOWN CONVERTERS”) and which is referred to here as the '673 application;

U.S. patent application Ser. No. ______ (attorney docket number 100.675US01 entitled “DYNAMIC RECONFIGURATION OF RESOURCES THROUGH PAGE HEADERS”) and which is referred to here as the '675 application;

U.S. patent application Ser. No. ______ (attorney docket number 100.676US01 entitled “SIGNAL ENHANCEMENT THROUGH DIVERSITY”) and which is referred to here as the '676 application;

U.S. patent application Ser. No. ______ (attorney docket number 100.677US01 entitled “SNMP MANAGEMENT IN A SOFTWARE DEFINED RADIO”) and which is referred to here as the '677 application;

U.S. patent application Ser. No. ______ (attorney docket number 100.679US01 entitled “BUFFERS HANDLING MULTIPLE PROTOCOLS”) and which is referred to here as the '679 application;

U.S. patent application Ser. No. ______ (attorney docket number 100.680US01 entitled “TIME START IN THE FORWARD PATH”) and which is referred to here as the '680 application;

U.S. patent application Ser. No. ______ (attorney docket number 100.681US01 entitled “LOSS OF PAGE SYNCHRONIZATION”) and which is referred to here as the '681 application;

U.S. patent application Ser. No. ______ (attorney docket number 100.684US01, entitled “DYNAMIC REALLOCATION OF BANDWIDTH AND MODULATION PROTOCOLS” and which is referred to here as the '684 application;

U.S. patent application Ser. No. ______ (attorney docket number 100.685US01 entitled “DYNAMIC READJUSTMENT OF POWER”) and which is referred to here as the '685 application;

U.S. patent application Ser. No. ______ (attorney docket number 100.686US01 entitled “METHODS AND SYSTEMS FOR HANDLING UNDERFLOW AND OVERFLOW IN A SOFTWARE DEFINED RADIO”) and which is referred to here as the '686 application; and

U.S. patent application Ser. No. ______ (attorney docket number 100.700US01 entitled “INTEGRATED NETWORK MANAGEMENT OF A SOFTWARE DEFINED RADIO SYSTEM”) and which is referred to here as the '700 application.

### TECHNICAL FIELD

The present invention relates generally to communication systems and in particular to the synchronization of timing between devices in a communication system.

### BACKGROUND

Wireless telecommunications systems, particularly cellular telephone communications systems, employ strategically placed base stations having transceivers that receive and transmit signals over a carrier frequency band to provide wireless communications between two parties. Recent mobile communication standards have lead to a plurality of different modulation standards being in use within a geographic region. Wireless communication providers have had to adapt their network hardware to accommodate unique protocols associated with each modulation standard. Some modulation standards that wireless communication networks currently operate with include, but are not limited to, Advanced Mobile Phone System (AMPS), code division multiple access (CDMA), Wide-band CDMA (WCDMA), time division multiple access (TDMA), Global System for Mobile communications (GSM), Cellular Digital Packet Data (CDPD), Enhanced Data rates for GSM Evolution (EDGE), General Packet Radio Service (GPRS), Integrated Digital Enhanced Network (iDEN), and Orthogonal Frequency Division Multiplexing (OFDM).

Call processing software, controlled by the base station server, handles large amounts of data. The call processing software receives the data from the base station as well as from the host cards through communication channels. An issue that has to be dealt with in this type of communication system is how to handle the data in the channels as well as the synchronization of the channels between the call processing software and the host cards. One approach to handling this data is by working on all the channels sequentially. This approach, however, requires either a single processor for each channel or an incredibly fast processor that can hop between packets of information. This approach is very expensive and inefficient. Another approach is the use of batch processing. This allows for a general purpose processor which can work on multiple channels at a time. However, general purpose processors have their own clocks and communication between these and host cards are complicated by problems with time synchronization.

For the reasons stated above, and for other reasons stated below that will become apparent to those skilled in the art upon reading and understanding the present specification, there is a need in the art for an effective way of maintaining time synchronization in an efficient manner.

### SUMMARY

The above-mentioned problems and other problems are resolved by the present invention and will be understood by reading and studying the following specification.

In one embodiment, a method of timing communications between a host card and call processing module is provided. The method includes attaching a time stamp message to a page of data samples that indicates when a first one of the data samples was received by a receive engine in the host card. Passing the data samples and the time stamp message to the call processing module and synchronizing communications between the host card and the call processing module based at least in part on the time stamp message.

In another embodiment, a method of synchronizing the time of communications in a communication system is provided. The method comprises reading a time clock used by an interface card when a first data sample in a group of receive data samples are received by the interface card. Attaching a time stamp message with the group of receive data samples, the time stamp message indicating the time read from the time clock. Transmitting the group of receive data samples and the time stamp message to a processing module and synchronizing communications between the interface card and the processing module based at least in part on the time stamp message.

In still another embodiment a host card for a communication system is provided. The host card includes at least one receive engine, a time clock and a synchronization circuit. The at least one receive engine is adapted to receive pages of data samples. The synchronization circuit is adapted to read the time clock when a first data sample in a page of data samples is received by the receive engine and attach a time stamp message to the page of data samples that indicates the time read.

In further another embodiment, a communication system is provided. The communication system includes a radio head unit and a server. The radio head unit is adapted to transmit and receive data samples from one or more communication devices. The server is in communication with the radio head card. The server includes a call processing module and at least on interface card. The call processing module is adapted to process communication signals. The at least one interface card is in communication with the call processing module and the radio head unit. Each interface card includes at least one receive engine, a time clock and a synchronization circuit. Each receive engine is adapted to receive pages of data samples. The synchronization circuit is adapted to read the time clock when a first data sample in a page of data samples is received by the receive engine and attach a time stamp message to the page of data samples that indicates the time read.

In still further another embodiment, another communication system is provided. The communication system includes a means for determining when a first data sample in a page of data samples is received by a receive engine in a interface card. A means for embedding a time stamp massage indicating when the first data sample was received in the page of data samples. A means of passing the page of data sample including the time stamp message to a processing module and a means of using the time stamp message to synchronize communications between the interface card and the processing module.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a communication system of one embodiment of the present invention;

FIG. 2A is a block diagram of a time synchronization system of one embodiment of the present invention;

FIG. 2B is a block diagram illustrating a reverse path in one embodiment of the present invention;

FIG. 3 is an illustration of a time synchronization system of one embodiment of the present invention; and

FIG. 4 is a flow chart illustrating a time synchronization in a reverse path of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide methods and systems of providing time synchronization and easy communication between host cards and call processing software modules. This allows for a general purpose server to perform batch processing and be more efficient in handling data with the call processing software. Time synchronization circuitry inside the radio head interface card (host card) helps to provide synchronization.

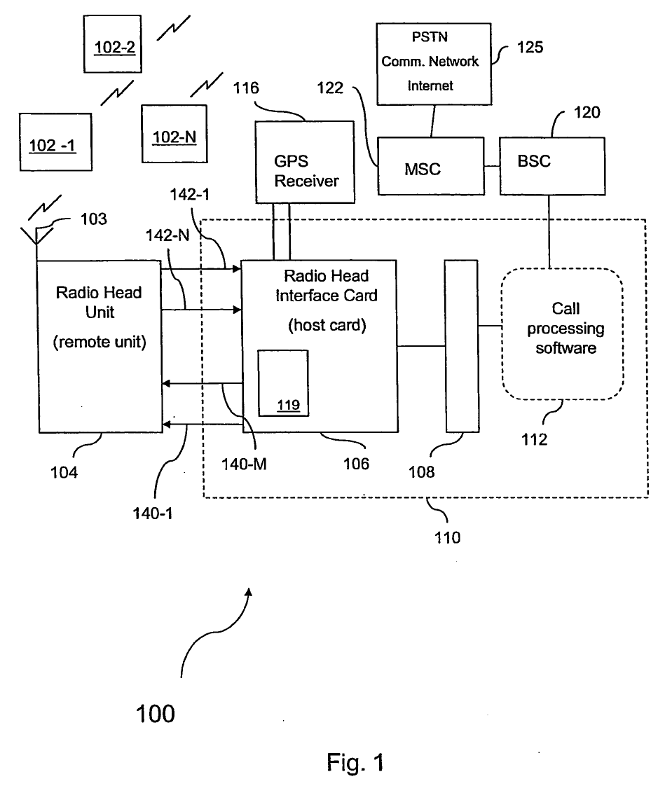

FIG. 1 is a block diagram of one embodiment of a communication system shown generally at 100 of the present invention. Communication system 100 includes one or more subscriber units 102-1 through 102-N (or mobile devices 102-1 through 102-N) within a service area of a radio head unit 104. Radio unit 104 is coupled to one or more servers 110 over a plurality of transport mediums 140-1 through 140-M in a forward direction and 142-1 through 142-N in a reverse direction. Server 110 is connected to one or more communication networks 125 (e.g. the public switched telephone network (PSTN), Internet, cable network, or the like). In one embodiment, communication system 100 further includes a base station controller (BSC) 120 coupled to server 110. In another embodiment, BSC 120 is further coupled to a mobile switching center (MSC) 122. BSC 120 supervises the functioning and control of the call processing of server 110. In one embodiment, BSC 120 is a radio network controller.

As illustrated in FIG. 1, radio head interface card 106 is coupled to the call processing software 112 via interface 108. In one embodiment, the radio head interface card 106 is a PCI-X card and the interface 108 is a PCI-X bus 108. In other embodiments, other high speed parallel and serial busses are used such as ATCA, PCI express, gigabit Ethernet, SCSI, rocket I/O, UDP/IP, TCP/IP link, serial ATA, card bus (for PCMIA cards) and the like. The radio head interface card 106 communicates with one or more communication networks 125 via call processing software 112. In one embodiment, each time the BSC 120 initiates frequency hopping, changing bandwidths, or changing amplitudes for one of the logical channels, the call processing software 112 (or call processing module) provides information to radio head interface card 106. In order to keep in unison, time synchronization between the call processing software 112 and the head interface card 106 is required. Embodiments of the present invention provide the synchronization. In one embodiment, the time synchronization is performed in part by a synchronization circuit 119 that is located in the radio head interface card 106 (or host card 106).

In one embodiment, the radio head interface card 106 is adapted with a global positioning system (GPS) receiver 116 to receive GPS time pulses. The received time pulses are used to control the internal time count of radio head interface card 106. The internal time count is used by the synchronization circuit 119 to synchronize communication between the server 110, the call processing module 112 and the radio head interface card 106. Although this embodiment employs a GPS server to receive time pulses, other embodiments employ other systems known in the art to receive time pulses.

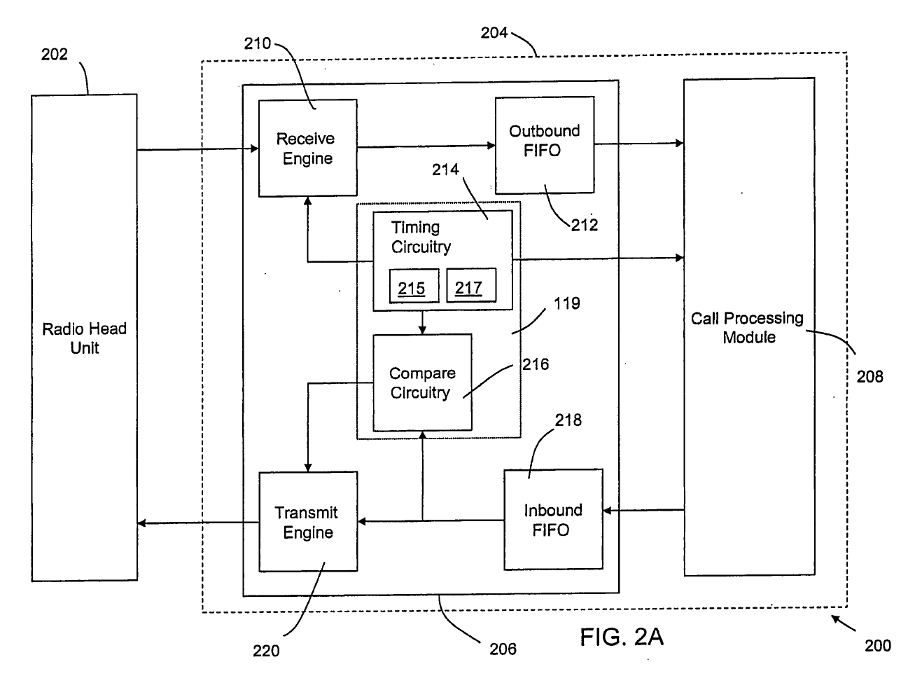

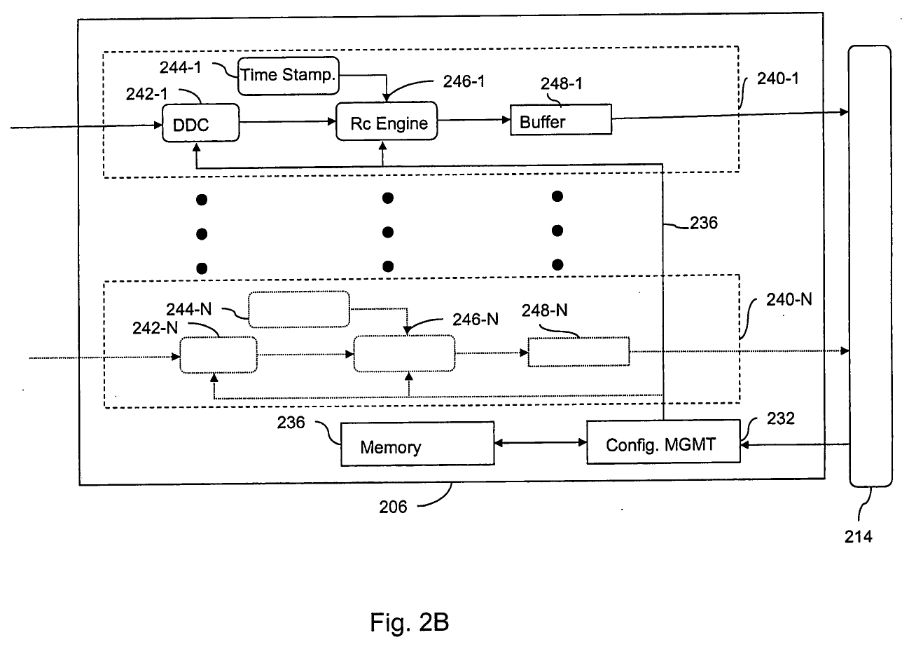

FIG. 2A is a block diagram of a time synchronization system shown generally at 200 of one embodiment of the present invention. As illustrated, a call processing module 208 is coupled to radio head interface card 206 which, in this embodiment, is located inside server 204. The call processing module 208 and the radio head interface card 206 are in communication with each other. The time used by the call processing module 208 (batch process time) and the time used by the radio head interface card 206 (real time) is different. Embodiments of the present invention synchronize the timing of messages between the call processing module 208 and the radio head interface card 206 with the help of a synchronization circuit 119 so that frequency hopping, bandwidth changing, protocol changing and the like are handled properly.

Communication signals in a reverse path of this embodiment are illustrated in FIG. 2A. As illustrated, communication signals including audio, video, and data signals, are sent from the radio head unit 202 to a receive engine 210 in the radio head interface card 206. In one embodiment the communication signals are complex RF data samples. The timing circuitry 214 includes a time clock 215 and a time stamp generator 217. The time stamp generator 217 is adapted to generate a time stamp message. The time stamp message (or time stamp) includes the value of the time clock 215 at the receipt of a first data sample at the receive engine 210. The time stamp is placed in the data samples at the receive engine 210. A page of complex RF data samples is formed by the outbound FIFO. The page of data includes the time stamp in a header. The call processing module 208 uses the time stamp message to determine when the data was received by the receive engine 210 and to synchronize timing of communications based at least in part on the time stamp.

Although, only one reverse transmission path is illustrated in FIG. 2A, multiple paths or channels can be used each having their own receive engine and buffers. For example, referring to FIG. 2B, multiple reverse paths though an interface card 206 is illustrated. As illustrated, multiple logic channels 240-1 through 240-N (multiple reverse channels) are present in this embodiment. The logic channels 240-1 through 240-N include associated digital down converters (DDC) 242-1 through 242-N, receive engines 246-1 through 246-N and buffers 248-1 through 248-N. To provide a better understanding of a reverse path, a description of how the data flows through channel 240-1 in one embodiment of the present invention is provided. In a reverse path, data samples are first received by DDC 242-1. Each DDC of the present invention is adapted to dynamically change the protocol of the data samples received. In particular, the memory 236 is adapted to store parameters associated with different protocols. The configuration management unit 232, upon direction from the call processing module 214, is adapted to retrieve parameters associated with a select protocol and apply them to the DDC. In response to the changing of parameters, the DDC converts the protocol of the data samples.

After the data samples have been processed by the DDC 242-1 they are passed on to the receive engine 246. At the receive engine 246-1, the time stamp message 244-1 is attached to the data samples. The time start message indicates when the receive engine first started to receive the data samples. The data samples along with their associated time start message 244-1 is then forwarded to buffer 248-1. The data samples and associated time stamp message 244-1 are then passed by the receive buffer 248-1 to the call processing module 214. Since the passing of the data is controlled by different clocks on different sides of the buffer 248-1 (i.e. real time by the interface card 206 and batch processing timing by the call processing module 214), the call processing module uses the time stamp message 244-1 to determine when the data samples were first received by the receive engine 246-1. This information is then used to synchronize communications between the call processing module 214 and the interface card 206.

In embodiments of the present application, the receive buffers 248-1 are continuously monitored for “buffer overflow.” Buffer underflow occurs when the call processing module is late in reading a receive page of data samples. When a buffer overflow condition occurs the extra data samples are discarded in a manner that the page synchronization is not lost. Once the receive buffer is no longer full, the page sequence resume intact. Overflow is further described in application number 100.686US01 which is herein incorporated by reference.

Referring back to FIG. 2A, data transmitted in a forward path, in one embodiment, is transmitted from the call processing module 208 through the radio head interface card 206 to the radio head unit 202. The forward path in the radio head interface card 206 includes an inbound FIFO 218 and a transmit engine 220. Compare circuitry 216 is used to control when the transmit engine 220 transmits data. The compare circuitry 216 is adapted to read a time start message embedded in a header of a page of data samples and compare it with a time clock 215 in timing circuitry 214. Once the time from the time clock 215 matches the time start message, the transmit engine begins transmitting the data to the radio head unit 202. Although, only one transmission path is illustrated in FIG. 2A, multiple paths or channels can be used each having there own buffers and transmit engines.

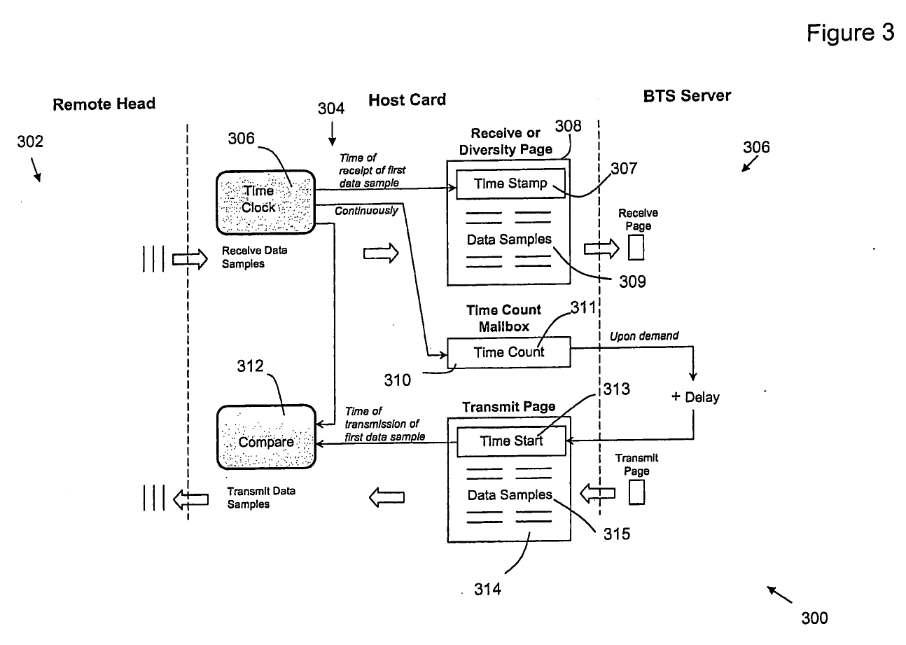

FIG. 3 illustrates a time synchronization system shown generally at 300 of one embodiment of the present invention. In particular, this embodiment illustrates the steps involved in synchronization. As illustrated, complex data samples from the remote head 302 are passed to the host card 304. The time the first data sample is received by the host card, as determined by the time clock 306 in the host card 304, is placed, via a time stamp 307, in a receive or diversity page 308 formed in a buffer. The receive page 308 also includes the data samples 309 which are associated with the time stamp. As illustrated, the time clock 306 also provides a time count 311 which is stored in a time count mail box 310. The time count 311 reflects a period time sampling of the time clock 306 which is continuously updated. The BTS server 306 which includes the software module, uses the time stamp 307 in the receive engine to determine when the data samples were received by the host card 304. The server 306 further uses the time count 311 in the time count mailbox 310 to calculate a desired time start to be placed in the header of a select page of data (the transmit page 314).

In one embodiment, a delay based in least in part on the time count 311 in the time count mailbox 310 is used to determine a desired time start 313 of a transmission page 314. Further in one embodiment, the time clock 306 is run at a 71 MHz rate and is incremented modulo 71,000,000. The time delay is exemplified in this embodiment by the following equation: time start=(time start+delay) modulo 71,000,000. A valid delay number range is between zero and 33,554,431 in this embodiment. The maximum delay, called Max Delay is slightly less than half the time stamp number range and slightly less than half a second (about 0.473 seconds). Actual transmission time has a granularity of +/−the data sample time. If the time start indicator (TSI) located within the transmit page 314 is active the time start is observed. Otherwise, it is ignored and data samples are sent contiguously. That is, the first RF data sample of the new page 314 is sent immediately after sending of the last data sample of the previous page 314 when the time start is being ignored. If the time start is not to be ignored, the host card 304 compares 312 the time start to the current time clock 306. If they match, the first data sample from the transmit page 314 is sent and subsequent data samples from the page 314 follow.

A match between the time clock 306 and the time start 313 is defined as agreement within the data sample tolerance (or range). The data sample tolerance in one embodiment is +/−½ the number of time clocks between data samples. As indicated in the above example, in embodiments of the present invention, the time clock 215 within the time circuitry 214 is counting at a much faster than the data sample rate. This allows for a range of time counts that are valid for the same data sample time. In one embodiment, the time clock is a monotonic increasing clock having a time count rate of 71 Mhz. In this embodiment, 70 time counts occur between data samples when the data sample rate is 1.0 Msps. By adding a time offset to the current time, a time start is valid for the current time count and also for the succeeding 70 counts (just before the next data sample time). The transmit engine 220 is adapted to transmit information received from the call processing module 208 to the radio head unit 202 when the time start≦current time+time offset wherein, in the above embodiment, the time offset equals 70.

In another embodiment the clock circuit 215 is a clock rollover. In an embodiment having a clock rollover frequency of 71 MHz, a 32-bit counter is used. This counter naturally rolls over at about 2³² or 4 billion clock pulses (which occurs in about a one minute time frame). However, instead of allowing the counter to rollover naturally, it is reset to zero upon every occurrence of a one second GPS pulse. This effectively makes it 71 million clock pulses (counts) to rollover. In one embodiment only half the range of time counts, centering on zero, are considered a valid count difference. This embodiment accounts for the rollover and the elimination of meaning for past and future times. An eight bit example of this would result in using the following equation: Difference=current time−time start+time offset; −127≦valid difference≦+127. The differences are counted with an absolute value greater than half the total range and are used to detect and correct time rollover. This correction is done using modulo 256 arithmetic. If difference is <−128 then corrected difference=difference+128 (correction one). If difference is >+127, then corrected difference=difference−128 (correction two). Correction one applies if the most significant bit (MSB) is one and any of the other “upper” bits are zero. Correction two applies if the MSB is zero and any of the other “upper” bits are one. Other embodiments, using various sized counters are contemplated and within the scope of the invention. Methods of correcting clock rollover used above are similarly applied in these other embodiments.

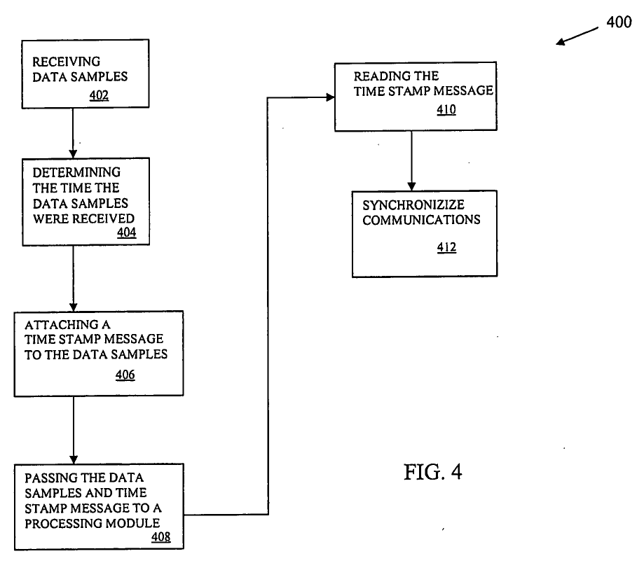

FIG. 4 is a flow chart 400 illustrating the flow of data samples in a reverse path of one embodiment of the present invention. As illustrated, the process starts by receiving data samples from a radio head unit (402). In one embodiment, the data samples are in a group of data samples such as a page of data samples. Once the data samples are received in a receive engine in an interface card (402), the time when the first data sample in the page was received is determined (404). In one embodiment, this is done by reading a time clock when the first data sample is received. A time stamp message is then attached to the page of data samples (406). The time stamp message indicates the time when the first data sample was received. The data samples and time stamp message are then passed on to the call processing module (408). Since, the call processing module is running on a different time than the interface card, the call processing module uses the time stamp in part to synchronize communications between the call processing module and the interface card.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of timing communications between a host card and call processing module, the method comprising:
attaching a time stamp message to a page of data samples that indicates when a first one of the data samples was received by a receive engine in the host card;
passing the data samples and the time stamp message to the call processing module; and
synchronizing communications between the host card and the call processing module based at least in part on the time stamp message.

2. The method of claim 1, further comprising:
reading a time clock when the receive engine receives the first data sample to determine the time stamp message.

3. The method of claim 1, further comprising:
monitoring a receive buffer for buffer overflow; and
when a buffer overflow condition occurs, discarding extra data samples in such a manner that page synchronization is maintained.

4. The method of claim 1, further comprising:
placing a time start message in a page of data samples to be passed from the call processing module to the host card, the time start message being based on the time stamp message and a delay.

5. The method of claim 4, further comprising:
comparing the time start message with a then current time from a time clock in an interface card; and
when the time start message matches the then current time of the time clock within a select tolerance, transmitting the data samples to a remote head.

6. A method of synchronizing the time of communications in a communication system, the method comprising:
reading a time clock used by an interface card when a first data sample in a group of receive data samples are received by the interface card;
attaching a time stamp message with the group of receive data samples, the time stamp message indicating the time read from the time clock;
transmitting the group of receive data samples and the time stamp message to a processing module; and
synchronizing communication between the interface card and the processing module based at least in part on the time stamp message.

7. The method of claim 6, wherein reading the clock occurs when the first data sample is received a receive engine of the interface card.

8. The method of claim 6, further comprising:
converting the group of receive data samples from one protocol to another protocol with a dynamically configured digital down converter.

9. The method of claim 6, further comprising:
monitoring a receive buffer for buffer overflow; and
when a buffer overflow condition occurs, discarding extra receive data samples in such a manner that synchronization is maintained.

10. The method of claim 6, further comprising:
creating a time start message based on the time stamp and a delay;
attaching the time start message to a group of transmit data samples to be transmitted from the processing module;
passing the transmit data samples with the time start message to the interface card; and
passing the data samples to a radio head when the time start message matches the then current time clock within a select tolerance.

11. A host card for a communication system, the host card comprising:
at least one receive engine adapted to receive pages of data samples,
a time clock; and
a synchronization circuit adapted to read the time clock when a first data sample in a page of data samples is received by the receive engine and attach a time stamp message to the page of data samples that indicates the time read.

12. The host card of claim 11, further comprising:
at least one outbound buffer adapted coupled between an associated receive engine and an output to a processing module.

13. The host card of claim 11, further comprising:
at least one dynamically configured digital down converter coupled between an input from a radio head unit and an associated receive engine.

14. The host card of claim 11, wherein the synchronization circuit further comprises:
compare circuitry adapted to compare a then current time form the time clock with a time start message in a header of a transmit page of data samples.

15. The host card of claim 14, further comprising
at least one transmit engine adapted to transmit the transmit page of data samples when the compare circuitry determines that a then current time matches the time start message in the header of the transmit page with a select tolerance.

16. A communication system comprising:
a radio head unit adapted to transmit and receive data samples from one or more communication devices; and
a server in communication with the radio head card, the server including,
a call processing module adapted to process communication signals, and
at least one interface card in communication with the call processing module and the radio head unit, each interface card including,
at least one receive engine adapted to receive pages of data samples,
a time clock; and
a synchronization circuit adapted to read the time clock when a first data sample in a page of data samples is received by the receive engine and attach a time stamp message to the page of data samples that indicates the time read.

17. The communication system of claim, 16 further comprising:
at least one outbound buffer adapted coupled between an associated receive engine and an output to a processing module.

18. A communication system, the communication system comprising:
a means for determining when a first data sample in a page of data samples is received by a receive engine in a interface card;
a means for embedding a time stamp massage indicating when the first data sample was received in the page of data samples;
a means of passing the page of data sample including the time stamp message to a processing module; and
a means of using the time stamp message to synchronize communications between the interface card and the processing module.

19. The communication system of claim 18, further comprising:
a means of determining a time start message based on the time stamp and a delay.

20. The communication system of claim 19, further comprising:
a means of transmitting a page of data samples when a time start message associated with the page of data samples matches the time of the time clock within a select tolerance.
